(19) United States
(12) Patent Application Publication
(10) Pub. No.: US 2010/0163463 A1
(43) Pub. Date: Jul. 1, 2010

(54) APPARATUS AND METHOD FOR SEPARATING CONTAMINATING PARTICLES FROM AN INCOHERENT MASS OF WOODY MATERIAL AND/OR VEGETABLE FIBERS

(76) Inventor: Antonio Dal Ben, San Biagio Di Callalta ( TV) (IT)

Correspondence Address: MANNAVA & KANG, P.C., 11240 WAPLES MILL ROAD, Suite 300, FAIRFAX, VA, 22030, US

(21) Appl. No.: 12/598,015

(22) PCT Filed: Apr. 28, 2008
(86) PCT No.: PCT/EP08/55148

§ 371 Date: Oct. 28, 2009

(30) Foreign Application Priority Data
Apr. 30, 2007 (IT) UD2007A000079

(51) Int. Cl. B07B 4/02

(52) U.S. Cl. 209/21; 209/133

(57) ABSTRACT

An apparatus and method for separating contaminating particles from an incoherent mass of woody material. The apparatus comprises a separation chamber into which the incoherent mass is introduced, first blowers associated with the separation chamber, to deliver a first flow of air in a direction substantially transverse to the direction of fall of the incoherent mass, and to divert the direction of fall of the woody materials and/or vegetable fibers with at least a first specific weight from the heaviest contaminants materials with a second specific weight, and dividing members disposed inside the separation chamber, in order to define different passage channels. The apparatus comprises first suction means associated with the first blowers, to perform a further separation on the woody and fiber materials with first specific weight. The apparatus comprises second blowers disposed so as to perform a third separation on a first part of the materials already separated by the first blowers.

### FIELD OF THE INVENTION

The present invention concerns an apparatus and a method for separating the particles and the granules of contaminating materials, consisting of silica, stones, other minerals, metals, plastic, glass, or other, from an incoherent mass of woody material and/or vegetable fibers, fresh or recycled, both humid and dry. The incoherent mass normally consists of wood particles and contaminating elements with a different specific weight. The elimination of contaminating elements from the woody material and/or the vegetable fiber is intended, advantageously, to allow the remaining wood particles to be subsequently used in industrial processes.

### BACKGROUND OF THE INVENTION

It is known that, in order to separate elements and/or materials of different specific weight, especially those of vegetable origin, such as fragments or particles of wood or similar, from an incoherent mass of material, apparatuses, or selectors, of the pneumatic type are employed.

Known pneumatic apparatuses are provided with a separation chamber into which the incoherent mass of woody material and/or vegetable fibers is introduced, mainly through gravity, and with one or more blower members, each of which is able to deliver a flow of air transversely to the direction of fall of the incoherent mass.

In this way, the materials that have a first, low specific weight, for example comprised between about 100 kg/m³ and about 250 kg/m³ apparent (on a dry base), amongst which woody ones are usually comprised, are diverted with respect to the direction of fall of the rest of the incoherent mass, and therefore separated, from other materials which have a second, high specific weight, for example higher than about 250 kg/m³, the so-called contaminants, such as silica, stones, other minerals, plastic, glass, or others initially present in the incoherent mass, which continue their fall, substantially without being subjected to the action of the flow of air emitted.

Known pneumatic apparatuses also comprise a plurality of dividing baffles disposed inside the separation chamber, and able to define different passage channels for the materials with first specific weight and with second specific weight, separated by the action of the flow of air. The dividing baffles prevent the separated materials from later re-mixing accidentally, during the continuation of their fall.

Pneumatic apparatuses are also known, from the German patent applications DE-A-24 56 140 and DE-A-43 39 532, in which suction members are associated with the blower members and at least partly recycle the air blown in order to feed the blower members once more, and thus define a circulation of air.

In known apparatuses, however, each blower member is able to perform only a single and rough separation of the materials, or several separations entrusted empirically to uncontrollable factors such as gravity and/or the aerodynamic incidence of the materials.

Therefore, in the common case where a plurality of separation passes need to be performed, for example in order to separate and isolate the woody fragments or particles from materials with a third specific weight, lower than the first, such as paper, plastic films or other, or so as to separate from each other woody materials with different specific weights, a corresponding plurality of blower members is required. An example of a known apparatus provided with a plurality of blower members is described in the German application for a utility model DE-U-20 2006 014 455.

The high number of blower members entails, however, an increase in both production and management costs of known apparatuses, and also requires a high overall quantity of air delivered inside the separation chamber.

This high overall quantity of air consequently entails the need for complex and costly filtering plants for the air before it is expelled outside, so as to avoid atmospheric and environmental pollution.

An apparatus is also known, from the German patent application DE-A-101 05 120, in which the suction member not only recycles the air but also effects a second separation of the material from one of the two parts already separated by the blower member. This known apparatus, however, does not guarantee a complete and effective separation of the materials that make up the incoherent mass.

Purpose of the present invention is to achieve an apparatus, and to perfect a relative method, which, starting from an incoherent mass of woody material and/or vegetable fibers, allow to separate in an effective manner the particles of wood from the contaminants, using a reduced number of blower members with respect to the number of separation passes to be performed.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, an apparatus for separating contaminating particles from an incoherent mass of woody material and/or vegetable fibers according to the present invention comprises at least a separation chamber inside which the incoherent mass of woody material and/or vegetable fibers is introduced from above, and first blower means associated with the separation chamber, and able to deliver a first flow of air transverse to the direction of fall of the incoherent mass, due to gravity, so as to perform a first separation by diverting the direction of fall of the materials which have at least a first specific weight, for example comprised between about 100 kg/m³ and about 250 kg/m³ apparent (on a dry base), from the materials with a second specific weight higher than the first, for example greater than about 250 kg/m³ apparent. The apparatus according to the invention also comprises dividing means disposed inside the separation chamber, and able to define different passage channels for the materials with first specific weight and for those with second specific weight, separated by the action of the blower means.

The apparatus according to the present invention also comprises suction means associated with at least the first blower means, and able to perform a recovery of the flow of air delivered by the latter and to again feed said blower means with the same air, substantially performing a recycling of the air. The suction means also determine a second separation on the materials with the first specific weight, substantially prolonging the action of diverting the flow of air, separating them from those with a third specific weight, for example lower than said first specific weight.

According to a characteristic feature of the present invention, the apparatus comprises at least second blower means disposed downstream of the first blower means and/or of the suction means, with respect to the direction of fall of the incoherent mass, and able to perform a third separation at least on a first part of the materials already separated by the first blower means, so as to separate from said first part, to a greater extent and with greater accuracy, at least the materials having the first specific weight from the materials having the second specific weight.

In this way, with the delivery of only two flows of air, and therefore using only two blower means, three separations of material are substantially performed, that is:
a first rough separation, performed directly with the first blower mean, in which the materials with a first specific weight are separated from those with second specific weight;
a second more refined separation, performed with the suction mean, in which the materials with a third specific weight are further separated from the materials with a first specific weight; and
a third finishing separation, performed with the second blower mean, in which from at least a part of the materials already roughly separated in the first separation, the materials having the first specific weight are further separated from the materials having the second specific weight.

The triple separation action made on the materials guarantees a greater efficacy and accuracy of separation of the materials with different specific weights, increasing the quality characteristics of the apparatus.

With the present invention we therefore have a reduced number of blower means with respect to the number of separations to be performed on the incoherent mass of material, which gives the advantage of a reduction in the overall quantity of air delivered into the separation chamber, and of both production and management costs of the apparatus.

Furthermore, the recovery and recycling action of the air delivered allows a further reduction in the overall quantity of air used, thus enabling to reduce the sizes and the bulk required by possible filtering units for the air to be released into the environment.

According to a variant, the apparatus comprises third blower means disposed, like the second blower means, downstream of the first blower means and/or the suction mean, and able to perform a fourth separation on a second part of the materials already separated by the first blower means. This gives the advantage of a further improvement in quality of the separation performed.

According to another variant, the baffle means is conformed so as to be able to be moved in order to selectively vary the amplitude and/or the shape of the channels through which the materials with a different specific weight pass.

This variation is advantageously actuated depending on the different materials that make up the incoherent mass and/or the different specific weights, and/or the different number of separations envisaged, or other, in order to optimize the separation of materials.

### BRIEF DESCRIPTION OF THE DRAWINGS

These and other characteristics of the present invention will become apparent from the following description of some preferential forms of embodiment, given as a non-restrictive example with reference to the attached drawings wherein:

FIG. 1 shows schematically a partially sectioned front view of a first form of embodiment of an apparatus for separating contaminating particles from an incoherent mass of woody material and/or vegetable fibers according to the present invention;

FIG. 2 shows schematically a partially sectioned front view of a second form of embodiment of an apparatus for separating contaminating particles from an incoherent mass of woody material and/or vegetable fibers according to the present invention;

FIG. 3 shows schematically a partially sectioned lateral view of a third form of embodiment of an apparatus for separating contaminating particles from an incoherent mass of woody material and/or vegetable fibers according to the present invention.

### DETAILED DESCRIPTION OF A PREFERENTIAL FORM OF EMBODIMENT

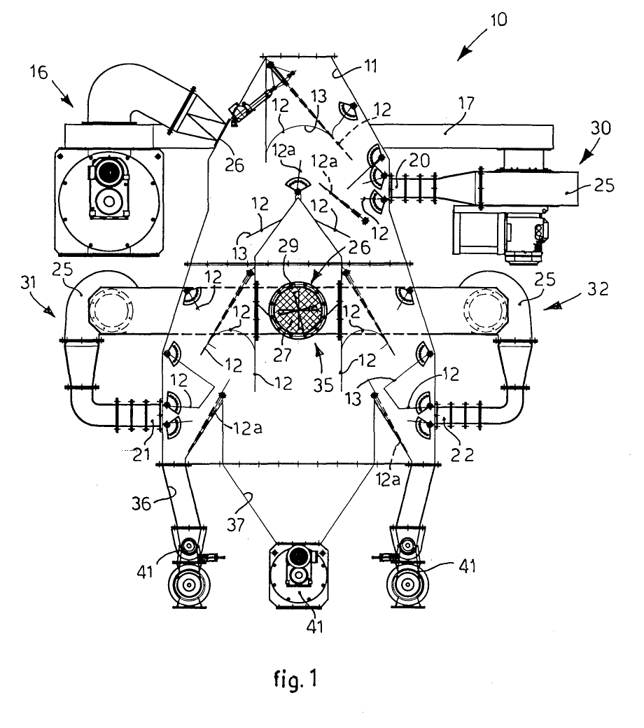

With reference to FIG. 1, an apparatus 10 according to the present invention is shown in its entirety, able to separate the particles and granules of contaminating materials, consisting of silica, stones, other minerals, metals, plastic, glass or other, from an incoherent mass of woody material and/or vegetable fibers.

In particular, the apparatus 10 is able to be fed from above with the incoherent mass consisting of particles of woody material and/or vegetable fibers and contaminants, and to separate from said mass the particles of woody material and/or vegetable fibers, on the one hand, and the contaminants, on the other hand, according to their different specific weights.

The apparatus 10, shown in FIG. 1, comprises a separation chamber 11, open upwards.

The apparatus 10 also comprises, in this specific case, three blower units, respectively a first 30, a second 31 and a third 32, associated with the separation chamber 11 downstream of its upper aperture, an upper suction unit 16 disposed in a position substantially opposite the first blower unit 30, and a lower suction unit 35 pneumatically connected both to the second blower unit 31 and also to the third blower unit 32.

In particular, the second blower unit 31 and the third blower unit 32 are disposed substantially at the same height, downstream of the first blower unit 30, with respect to the direction of fall of the incoherent mass.

The suction unit 16 is connected, outside the separation chamber 11, to the first blower unit 30, by means of a connection pipe 17, so as to send the air sucked inside the separation chamber 11 into the first blower unit 30 and thus perform a recycling, at least partial, of the used air.

The lower suction unit 35, in this case, is able to effect only the recovery and recycling of the air, in order to redistribute it between the second blower unit 31 and the third blower unit 32.

Each blower unit 30, 31 and 32 comprises a respective nozzle 20, 21 and 22 open inside the separation chamber 11 and from each of which a determinate flow of air is able to be delivered in a direction substantially transverse to the direction of fall of the incoherent mass.

A relative motorized blower turbine 25 is also part of each of the blower units 30, 31 and 32, disposed outside the separation chamber 11 and able to generate said flow of air delivered by the nozzle 20, 21 and 22. In particular, the connection pipe 17 is directly connected with the relative blower unit 30, 31 and 32 through the blower turbine 25.

Both the suction unit 16 and the suction unit 35 comprise a suction valve/filter 26 provided with a protection grid 27 facing towards the inside of the separation chamber 11, and able to stop parts of the mass from being accidentally sucked into the pipe 17 that connects the suction unit 16 and the suction unit 35 to the relative blower unit 30, 31 and 32.

Advantageously, both the suction unit 16 and also the suction unit 35 also comprise a cleaning member 29, with blades, disposed in association with the protection grid 27 in order to clean from the latter possible parts of the mass that may adhere thereto.

The second blower unit 31 and the third blower unit 32 are opposite each other with respect to a median longitudinal axis X of the separation chamber 11.

The apparatus 10 also comprises a plurality of dividing means, consisting for example of fixed dividing baffles 12, and a plurality of mobile dividing baffles 12a, operationally positioned inside the separation chamber 11, so as to define corresponding passage channels 13, for the woody material and/or vegetable fibers and the contaminants, after their separation.

In this specific case, the mobile dividing baffles 12a are advantageously disposed in proximity to the aperture of the respective nozzles 20, 21 and 22 of the three blower units 30, 31 and 32. The specific positioning of the individual mobile dividing baffles 12a can be chosen, on each occasion, in order to determine a specific orientation of the flow of air delivered, and to impact, with the best angle, against the falling incoherent mass, so as to divert a part of the materials that form it, and in this way perform the specific separations.

These separations occur due to the effect of the different specific weights of the materials which form the incoherent mass.

For example, the part of the materials diverted by the flow of air delivered by the first nozzle 20, amongst which there is the woody material and/or vegetable fibers, has at least a first specific weight, relatively low, comprised between about 100 kg/m³ and about 250 kg/m³ apparent (on a dry base), while the part of material that continues its fall without being diverted, such as silica, stones or other contaminating minerals, has a second specific weight, higher than the first and therefore greater than 250 kg/m³ apparent.

The fixed dividing baffles 12 installed in proximity to the blower unit 15 are disposed so as to define the correct speed of feed of the incoherent woody mass.

Other fixed dividing baffles 12 are disposed in proximity to the suction unit 16, so as to define a passage through which the materials with a third specific weight, lower than the first specific weight, are taken in by the action of the suction unit 16.

These latter materials normally consist of very light contaminants or with very aerodynamic surfaces, such as plastics, nylon, paper, vegetables or others, lighter than wood, and of contaminated wood dust.

The suction unit 16 then performs a second separation of the materials using the same flow of air that determined the first, substantially prolonging the range of the lighter materials.

In this case, the incoherent mass fed into the separation chamber 11 is subjected to a first separation in correspondence with the first blower unit 30, so that the materials having at least the first specific weight are diverted with respect to the materials having the second specific weight, which continue their normal direction of fall.

The upper suction unit 16 then determines a further separation in which it sucks in, from the separated mass, those materials with the third specific weight.

The second blower unit 31 is regulated so as to perform a further separation of the materials with a first specific weight with respect to those with the second specific weight which passed through together with the first during the first separation. Similarly, the third blower unit 32 is regulated so as to perform a further separation of the materials with a first specific weight which have not been separated during the first separation from the materials with the second specific weight.

The apparatus 10 also comprises, in an exit zone thereof, a plurality of exit pipes, in this specific case three, respectively a first 36 for heavy contaminants that have not been diverted, a second 37 for particles of woody material and/or residual vegetable fibers, and a third 39 for heavy contaminants.

Advantageously, at the end of each exit pipe 36, 37 and 39, respective solid valves 41 are associated.

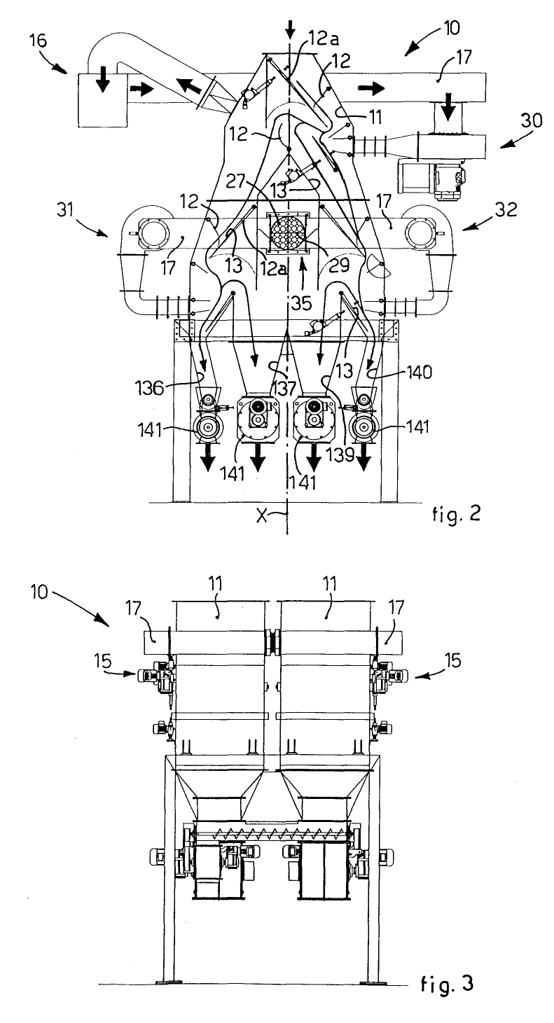

In the form of embodiment shown in FIG. 2, where the same reference numbers are used for components equal to those in the form of embodiment shown previously, the apparatus 10 according to the present invention comprises three blower units, respectively, a first upper one 30, and a second 31 and third 32, both lower.

In this specific case, the apparatus 10 comprises four exit pipes, respectively a first 136 for heavy contaminants that have been diverted, a second 137 for the lighter particles of woody material and/or vegetable fibers, a third 139 for the heavier particles of woody material and/or vegetable fibers and a fourth 140 for heavy contaminants.

In this case too, at the end of each exit pipe 136, 137, 139 and 140, respective solid valves 141 are associated.

In the form of embodiment shown in FIG. 3, the apparatus 10 can be doubled or, in some cases, tripled.

It is clear, however, that modifications and/or additions of parts or steps may be made to the separation apparatus 10 and method as described heretofore, without departing from the field and scope of the present invention.

In this specific case, the blower units 30, 31 and 32, are advantageously of the type with variable delivery.

It is also clear that, although the present invention has been described with reference to specific examples, a person of skill in the art shall certainly be able to achieve many other equivalent forms of apparatus and method for separating contaminating particles from an incoherent mass of woody material and/or vegetable fibers, having the characteristics as set forth in the claims and hence all coming within the field of protection defined thereby.

1. An apparatus for separating contaminating particles from an incoherent mass of woody material and/or vegetable fibers, comprising:
a separation chamber inside which said incoherent mass of woody material and/or vegetable fibers is able to be introduced from above,
first blower means associated with said separation chamber, and able to deliver a first flow of air in a direction substantially transverse to the direction of fall of said incoherent mass, so as to divert the direction of fall of the woody materials and/or vegetable fibers with at least a first specific weight from the heaviest contaminants materials with a second specific weight higher than said first specific weight, and
dividing means disposed inside said separation chamber, and able to define different passage channels for said materials with first specific weight and with second specific weight, and which also comprises first suction means located along the separation chamber in an opposite position with respect, and pneumatically connected, to said first blower means, and able to both recover and recycle at least partly of the flow of air delivered by said blower means, and also to determine a further separation on said woody and fiber materials with first specific weight, separating from the latter the lightest contaminants materials which have a third specific weight lower than said first specific weight, the apparatus further comprising
at least second blower means disposed downstream both of said first blower means and of said first suction means, with respect to the direction of fall of the incoherent mass, and able to perform a third separation at least on a first part of the materials already separated by said first blower means and by said first suction means, so as to separate at least from said first part the woody and fibers materials having the first specific weight from the heavy contaminants materials having the second specific weight.

2. (canceled)

3. The apparatus as in claim 1, further comprising second suction means pneumatically connected to said at least second blower means, and wherein said first and second suction means are connected to the respective blower means, by means of a relative connection pipe disposed outside said separation chamber.

4. The apparatus as in claim 3, wherein each of said first and second suction means comprises at least a suction valve provided with a protection grid facing towards the inside of said separation chamber.

5. The apparatus as in claim 4, wherein said first and second suction means also comprise a cleaning member with blades, disposed in connection with said protection grid.

6. The apparatus as in claim 1, wherein each of said blower means comprises at least a nozzle open inside said separation chamber and able to deliver said flow of air, and a blower turbine able to generate said flow of air delivered by the nozzle.

7. The apparatus as in claim 1, further comprising a plurality of exit pipes, in which said materials are able to be channeled in outlet after their separation, and wherein at the end of each exit pipe respective solid valves are associated.

8. (canceled)

9. The apparatus as in claim 1, comprising a third blower unit disposed substantially at the same height with respect to said second blower means, downstream of the first blower unit, with respect to the direction of fall of the incoherent mass, and able to perform a fourth separation on a second part of materials already separated from said first blower means.

10. The apparatus as in claim 1, wherein said dividing means is conformed so as to be able to be moved in order to selectively vary the amplitude and/or the shape of said passage channels, in accordance with determinate separation parameters.

11. The apparatus as in claim 1, comprising two separation chambers disposed substantially parallel to each other, and each provided with relative blower means, suction means and dividing means.

12. The apparatus as in claim 1, said blower means have a variable delivery.

13. A method for separating contaminating particles from an incoherent mass of woody material and/or vegetable fibers, which incoherent mass is introduced from above into a separation chamber, said method comprising:
a first separation step in which by means of a flow of air delivered by first blower means in a direction substantially transverse to the direction of fall of the incoherent mass, the direction of fall of the woody materials and/or vegetable fibers with at least a first specific weight is diverted from the heaviest contaminants materials with a second specific weight greater than the first specific weight;
a second separation step in which by means of a suction performed by first suction means, located along the separation chamber in an opposite position with respect to said first blower means, pneumatically connected to said first blower means and acting on said flow of air delivered by said first blower means, a further separation is performed on said materials with a first specific weight, separating from the latter the lightest contaminants materials which have a third specific weight lower than said first specific weight, the method further comprising
a third separation step in which by means of a flow of air delivered by at least a second blower mean, disposed downstream both of said first blower means and of said first suction means, towards at least a part of the materials already roughly separated in said first separation step, and in said second separation step, the woody and fibers materials having the first specific weight are further separated from the heavy contaminants materials having the second specific weight.
